(19) United States
(12) Patent Application Publication
(10) Pub. No.: US 2008/0124599 A1
(43) Pub. Date: May 29, 2008

(54) Zinc-Air Battery

(76) Inventor: Dong-Soo Baik, Lyunggi-do (KR)

Correspondence Address: COLEMAN SUDOL SAPONE, P.C., 714 COLORADO AVENUE, BRIDGE PORT, CT, 06605-1601, US

(21) Appl. No.: 11/884,136

(22) PCT Filed: Mar. 22, 2005
(86) PCT No.: PCT/KR05/00815

§ 371 Date: Oct. 29, 2007

(51) Int. Cl. H01M 12/06

(52) U.S. Cl. 429/29; 429/27

(57) ABSTRACT

The present invention discloses a zinc-air battery. It adopts a tubular cathode tube to accelerate oxygen supply and cooling by facilitating air flow, and a zinc plate or powder is used for anode, and caustic potash (KOH) is used for electrolyte. Especially for the sake of user convenience, the electrolyte container containing caustic potash is separated from the battery stack in normal times, but it is combined with the battery stack when using the battery for electrolyte to be inserted into the battery to generate electricity. For this, under the electrolyte container 300 containing electrolyte is arranged a battery stack 200 to have electrolyte supplied when necessary, and both the battery stack 200 and the electrolyte container 300 are housed in the battery casing 100.

### TECHNICAL FIELD

The present invention relates to a zinc-air battery, and more specifically to a zinc-air battery, in which a battery stack containing zinc powder and copper anode in the inside of the battery casing and an electrolyte container is installed at the top of the battery stack for the electrolyte in the electrolyte container to be supplied into zinc powder when necessary, so that electricity can be generated ideally.

### BACKGROUND ART

Conventionally, the zinc-air battery is widely used due to its safety and high specific energy value.

The mainly used types include the button battery, which is widely used as primary battery, and fuel cell types (U.S. Patent Application No. 2002-0142203 and U.S. Pat. No. 6,057,052), in which the zinc of the anode material can be exchanged.

However, as one reason for its limited use, we can say the short shelf life. It is because the power is lost due to the loss of performance of the electrolyte from the formation of potassium carbonate by the reaction of caustic potash with carbon dioxide in air, and due to the production of zinc oxide from the reaction between zinc powder and aqueous solution electrolyte.

Meanwhile, many researches have been made to prevent such problems, but they still remain as unsolved problems.

A representative reason is that once you start using a zinc-air battery, it is consumed completely at once, so in general, it is used mainly for emergency. On the other hand, in case the battery power is already reduced due to internal discharge, the user may experience jeopardy.

Accordingly, the most preferable type is to keep electrolyte and fuel metal separately, and by doing so, it is possible to remove the two causes mentioned above.

The type of activating by injecting water from outside has been already developed. But this type of battery has to have caustic potash contained in the battery in advance, and even if it is packaged, it is impossible to remove completely the reaction between caustic potash that contains moisture and carbon dioxide that infiltrates little by little.

Moreover, by moisture absorption due to deliquescence of caustic potash, there is even a possibility of corrosion reaction inside of the battery.

Another method is to prepare caustic potash solution and inject it when using. This could not only injure the human body due to toxicity of caustic potash solution but also its handling is inconvenient. In general, most users want batteries of the type for which safe and quick injection is possible.

The performance of zinc-air battery is greatly affected also by the structure of the tubular cathode. If the space for air passing is reduced to decrease the size of the battery, the flow of air is not facilitated, so the performance decreases.

In view of this, most of the conventional arts use plate-form cathodes, and some of the arts (for example, U.S. Pat. No. 6,309,771B and U.S. Pat. No. 6,190,792) use a tubular structure. However, such arts are cases of charging and discharging electricity while rotating a flexible battery having anode and electrolyte.

To facilitate the flow of air and reduce the space taken, it is most preferable to use a tubular cathode, all the more, especially if it is a small disposable battery.

### DISCLOSURE OF INVENTION

### Technical Problem

### Technical Solution

To achieve the above objects, there is provided a zinc-air battery, in which a zinc plate or metal zinc powder is used as anode, and air or oxygen is used as oxidizer, and aqueous solution of caustic potash is used as an electrolyte, the zinc-air battery comprising: an electrolyte container containing electrolyte, a battery stack that is arranged under said electrolyte container so as to have electrolyte supplied when necessary from said electrolyte container, and a battery casing that houses both said electrolyte container and battery stack.

Preferably, said electrolyte container is provided with a plurality of electrolyte outlets that are formed at the bottom in a protrusion shape so as to be inserted into the inside of said battery casing.

Preferably, each of the electrolyte outlets of said electrolyte container maintains a sealed state after electrolyte is filled, and is sealed by a scaling film that allows electrolyte be discharged if it is penetrated.

Preferably, an outward protrusion that can raise the sealing power is formed on the outer circumference of the electrolyte outlet of said electrolyte container.

Preferably, said electrolyte container has a size that fits into the upper half of said battery casing, and a fastening slot is formed on the outer circumference to be inserted the inward protrusion end of said battery casing so that a temporary position can be held immovable.

Preferably, said electrolyte container is prevented from breaking away because, when its exposed top surface is pressed while it is inserted in said battery casing, the exposed top surface is inserted lower than the inward protrusion end of said battery casing.

Preferably, said electrolyte container has air-flowing slots, which induces air to flow to the inside of said battery casing, formed on the outer circumference.

Preferably, the electrolyte filled in said electrolyte container is caustic potash solution.

Preferably, said battery stack comprises a stack case having a predetermined internal space, a plurality of anode tubes inserted into said stack case, zinc powder filled in said anode tubes, a cathode holder arranged so as to seal the upper side and lower side of said stack case and having a plurality of holder holes, and a plurality of cathode tubes, in which the upper and lower ends are supported by the holder hole of said cathode holder and the bottom holding part of the battery casing, respectively, and air can be moved to the center.

Preferably, each of said anode tubes made in rectangular shapes by bending thin copper plates is coated with electrically insulating coated portion on the whole of the outer side and the upper and lower ends of the inner side.

Preferably, the electrical insulation-coated portion of said anode tube is made of electrically insulating polymer adhesive agent for multiple connections, and the anode tubes are housed in said stack case while they are continuously connected each other by said electrical insulation-coated portion.

Preferably, each of said cathode tubes has a plurality of fine holes formed on the cylindrical surface excluding the upper and lower joint ends 231 for air to flow inward, and a catalyst-coated layer is applied on the circumference that has the fine holes formed.

Preferably, said catalyst-coated layer is composed of a primary coated layer made of activated carbon mixed with Teflon® content of 60 to 90% by weight ratio, and a secondary coated layer made of activated carbon mixed with Teflon® content of 30 to 60% by weight ratio.

Preferably, the cathode holder of said battery stack is provided with a plurality of protrusion rims formed on the circumference of said holder hole, and after the cathode tube is inserted into each of holder holes, the protrusion rim around the holder hole and the upper joint end of the cathode tube is joined by means of a metal sleeve.

Preferably, said cathode holder is arranged between holder holes, further comprises a plurality of electrolyte filling inlets for injecting electrolyte.

Preferably, the electrolyte filling inlet of said cathode holder has a dual structure consisted of a protruded tube portion and a slant insert tube portion arranged in the center of the protruded tube portion, so that the slant insert portion can prick to break said sealing film.

### ADVANTAGEOUS EFFECTS

The present invention is proposed to solve such conventional problems, and the primary task of the present invention is to develop a disposable zinc-air battery of a new type that can solve the unsatisfactory problems of conventional art by various basic demonstrated experiments.

Accordingly, the greatest object of the present invention is to provide a zinc-air battery having a long-lasting shelf life, by keeping the electrolyte separately.

Namely, it is to provide a zinc-air battery that can be kept for a long period by putting it in a polyethylene or polypropylene container and then sealing the inlet with a film made of the same kind or vinyl chloride film, and prevents the penetration of carbon dioxide as well as breaking from mechanical impact. The concentration of caustic potash in the electrolyte, which is the main component of electrolyte, is kept high, so that the solution is maintained in a state not frozen in storage at temperatures as low as approximately −30° C.

Another object of the present invention is to provide a zinc-air battery that can accomplish high performance even with a relatively small size by providing with tubular cathodes having internal air passages.

Namely, by making air move swiftly upwardly through the cathode tubes, the cooling effect is increased that much and the supply of oxygen is facilitated so as to improve the performance, and furthermore, because infiltration of oxygen into the cathode tube is made easier since the pressure inside of the tube is higher than that of outside surroundings, the flow of air flowing inside of the tube can be helpful to the reactivity with the electrode of electrolyte adjoining the outside of the tube.

Yet another object of the present invention is to provide a zinc-air battery that is easy to assemble with higher productivity, since the structure becomes simpler in case of constructing plural cells by making the penetrated cathode tubes.

Yet another object of the present invention is to provide a zinc-air battery that is far safer with the mechanical strength increased by arranging the weak cathode tubes inside and constructing the strong anodes in close contact with the outer wall. Namely, most of the zinc-air batteries are in a form with the cathode surfaces facing outward, making special mechanical protection necessary, so additional increase in weight or volume ensues; however such disadvantages can be removed by the above-mentioned construction.

Yet another object of the present invention is to provide a zinc-air battery that can greatly improve operability by arranging an electrolyte container containing electrolyte at the top of the battery, and keeping a film blocking the inlet separated at a pre-determined interval from the solution filling hole of the battery, and allowing the film be torn for electrolyte to be injected when the film comes into close contact with the battery by external force.

Yet another object of the present invention is to provide a zinc-air battery with safety improved even while in motion, by assembling the filling hole of the battery and the opening of the electrolyte container sealed tight even after electrolyte is introduced.

Yet another object of the present invention is to provide a zinc-air battery that can easily connected to electrical equipments.

### DESCRIPTION OF DRAWINGS

These and other features, aspects, and advantages of preferred embodiments of the present invention will be more fully described in the following detailed description, taken accompanying drawings. In the drawings:

FIG. 1 is a whole block diagram of a zinc-air battery according to an embodiment of the present invention;

FIG. 2 is a partial perspective view showing a battery stack of the present invention;

FIG. 3 is a front view and bottom view showing an electrolyte container of the present invention;

FIG. 4 is a partly cutaway sectional view showing the action of the present invention;

FIG. 5 shows a top plan and longitudinal sections of the cathode holder of the present invention;

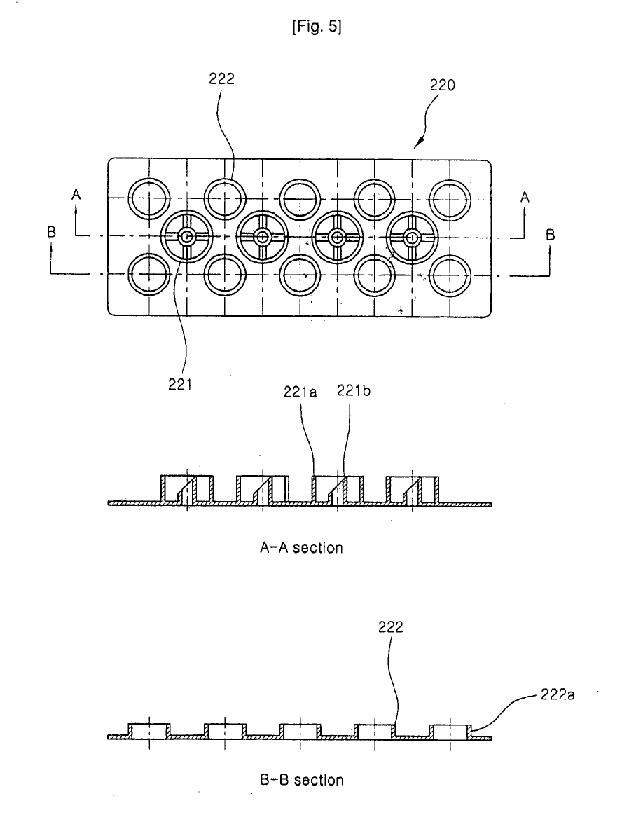

FIG. 6 is a manufacturing process diagram of the cathode tube of the present invention;

FIG. 7 shows a vertical section and an enlarged detail of the cathode tube of the present invention;

FIG. 8 shows a development and a perspective illustration of the anode tube of the present invention.

### BEST MODE

Below will be described a preferred embodiment of the present invention with reference to the attached drawings.

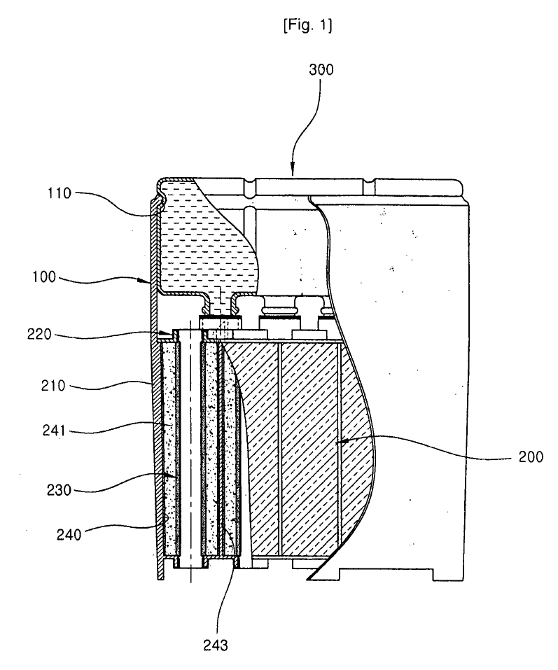

As shown in FIG. 1, a zinc-air battery according to the present invention comprises an electrolyte container 300 containing electrolyte, a battery stack 200 arranged under the container 300 so as to have electrolyte supplied from the electrolyte container 300 when necessary, and a battery casing 100 that contains both the battery stack 200 and the electrolyte container 300.

The battery casing 100 is in such a structure that the battery stack 200 and the electrolyte container 300 are combined to be kept inside and air used as oxidizer goes in and out smoothly.

The battery casing 100 is made by injection molding of frequently used low-priced plastic materials such as PE, PP, PVC and ABS.

As shown in FIG. 1, in the bottom holding part of the battery casing 100 is inserted into the lower end of the anode tubes 230 to form the part for functioning as holder, and the upper part of the battery casing 100 is completely open. And, the upper end is formed with an inward protrusion end 110. This protrusion end 110 is made to hold the electrolyte container 300, and is inserted in a fastening slot 320 formed on the outer circumference of the electrolyte container 300. At this time, the battery stack 200 and the electrolyte container 300 are kept in a state inserted less by as much as a pre-determined interval h. When using, press from outside the top of the electrolyte container 300 made of a softer material than the battery casing 100, then the protrusion end 110 gaps a little and is pushed into the battery casing 100, while the protrusion end 110 of the battery casing is inserted into the fastening slot 320 formed on the electrolyte container 300 to make the electrolyte container 300 join with the battery casing 100.

Owing to the inserting of the protrusion end 110 in the fastening slot 320, once the electrolyte container 300 is inserted into the battery casing, it is not to be slipped out unless it is forcibly pulled out, so the user can continue to use it safely.

The battery stack 200 assembled inside the battery casing 100 has a plurality of cathode tubes 230 and a plurality of anode tubes 240 containing zinc powder 241 and it actually plays a role of generating electricity.

Each of the anode tubes 240 is composed of zinc powder 241 and a negative plate 242 made of copper as material, and the electrolyte container 300 contains electrolyte 340 inside thereof. Also, the electrolyte container 300 has air-flowing slots 330 for air to pass, a fastening slot 320 for the protrusion end 110 of the battery casing 100 to be inserted, and electrolyte outlets 310 inserted into the electrolyte filling inlets 221 formed on a cathode holder 220 of the battery stack 200 for filling out electrolyte. Each of the electrolyte outlets 310 has an outward protrusion 311 formed on their outer circumference, so it is possible to fit the outward protrusion 311 into the electrolyte filling inlet 221, and owing to it, leaking of electrolyte can be prevented.

The cathode tube 230 is tubular, and the inside is in a form for air to flow in.

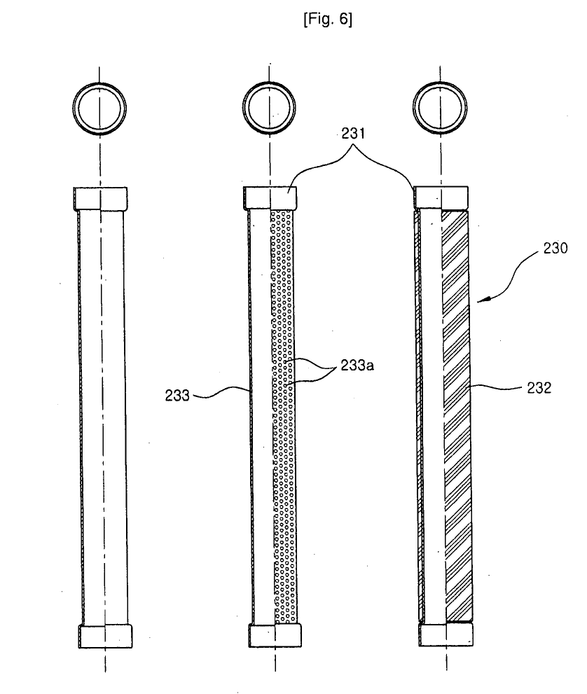

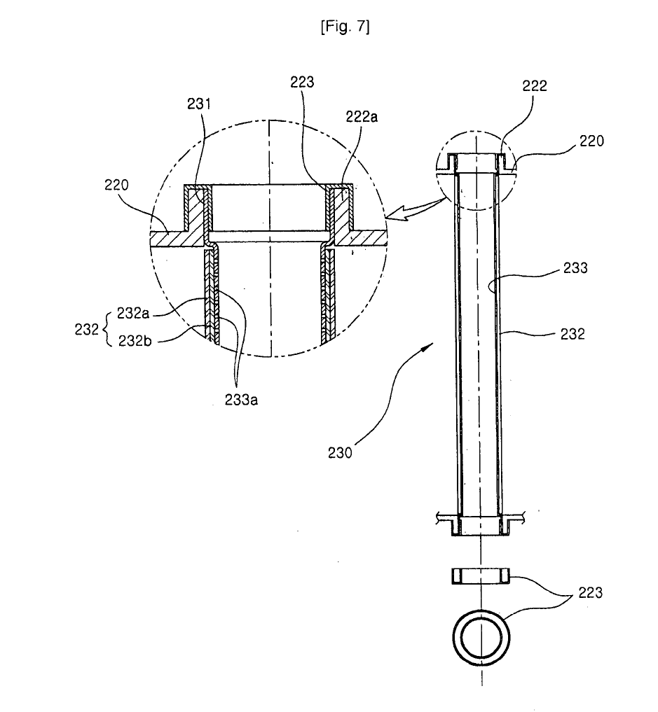

Namely, as shown in FIGS. 6 and 7, a plurality of fine holes 233a are formed on the cylindrical surface excluding the upper and lower joint ends 231, and the circumference having the fine holes formed is coated with a catalyst-coated layer 232.

At this time, the catalyst-coated layer 232 is composed of a primary coated layer 232a made of activated carbon mixed with Teflon® content of 60 to 90% by weight, and a secondary coated layer 232b made of activated carbon mixed with Teflon® content of 30 to 60% by weight.

Of course, the cathode tube 230 exhibits practically the same function even if it is a rectangular tube, and the flow of air is made by natural convection. At this time, since the temperature of the battery rises when electricity is generated, a chimney phenomenon is induced in which the internal air of the cathode tubes moves upwardly. By such a chimney effect, the flow of air is facilitated, resulting in consistent output.

Thanks to this, it has various advantages as follows.

First, the flow of air gets faster to make the supply of oxygen easy, and since the pressure of oxygen is higher in the inside of the tube, the infiltration outward is easier to make output increase.

Second, the structure of the battery becomes simpler and solider.

Third, unnecessary space is reduced to make it compacter and get energy density higher.

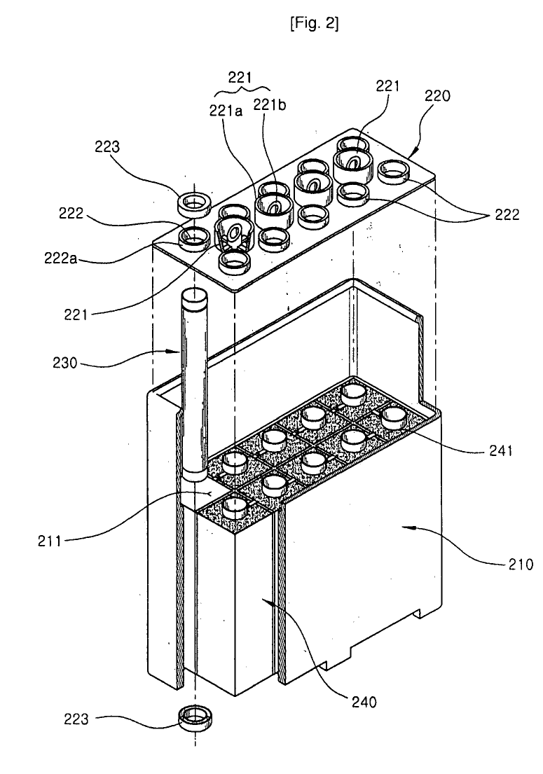

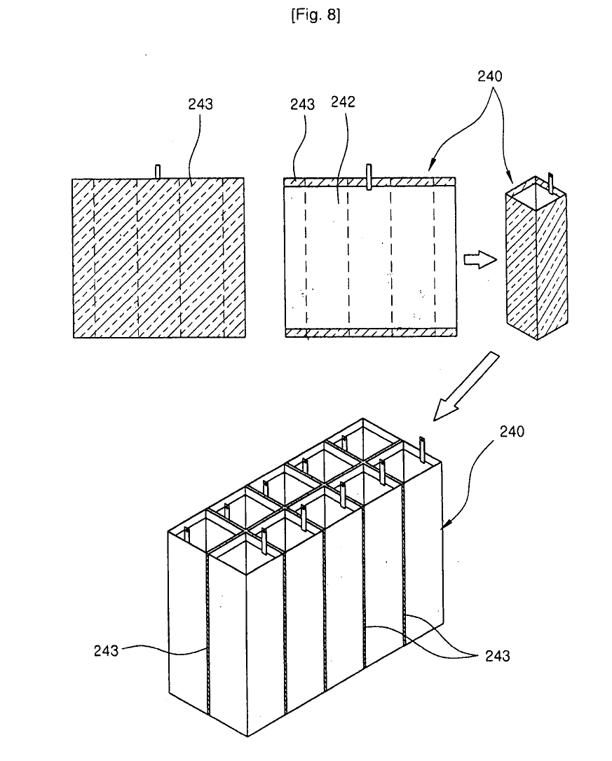

Next, as shown in FIG. 2 and FIG. 6, the circumference of the cathode tube 230 is formed with a catalyst-coated layer 232. And, the circumference of the cathode tube 230 is provided with a space to be filled with zinc powder 241. The zinc powder 241 filled in this space encloses the cathode tube 230, while the outside is enveloped by a rectangular anode plate 242 (FIG. 8). The negative terminals and positive terminals of the cell formed by the cathode tube 230 and anode plate 242 are connected respectively to the opposite terminals of the adjacent cell, namely, the positive terminal and negative terminal.

The anode plate 242 has a thin rectangular column form, and for insulation with adjacent anode plates 242, a plastic partition, for example, is used or the exterior is coated with an insulation-coated portion 243 such as epoxy. At this time, the insulation-coated portion 243 is made of electrically insulating polymer adhesive agent for multiple connections. To assemble, connect each of the cathode tubes 240 continuously each other by the insulation-coated portion 243 and have them built in the stack case 210, and then insert the stack case 210 again into the battery casing 100.

The present invention used zinc powder that is used in the conventional alkaline battery or zinc-air battery. Zinc powder with a diameter of average 0.1 to 0.2 mm was filled in each cell enveloped by a thin copper plate. The thin copper plate plays a role of electrode that collects and sends electrons obtained by oxidation of zinc powder.

The battery stack 200 according to the present invention comprises a stack case 210 having a predetermined internal space 211, anode tubes 240 that are inserted into the inside of the stack case 210, zinc powder 241 filled in the anode tubes 240, a cathode holder 220 arranged so as to seal the upper side and lower side of the stack case 210 and has a plurality of holder holes 222, and cathode tubes 230, in which the upper and lower ends are supported by the holder holes 222 of the cathode holder 220 and air can be moved to the center.

Here, the cathode holder 220 of the battery stack 200 is provided with a plurality of protrusion rims 222a formed around the holder holes 222. After the cathode tube 230 is inserted into each of the holder holes 222, the protrusion rim 222a around the holder hole 222 and the upper joint end 231 of the cathode tube 230 is joined by means of a metal sleeve 223. The lower end of the body 230 is inserted into the bottom holding part of the battery casing 100 by means of the metal sleeve 223.

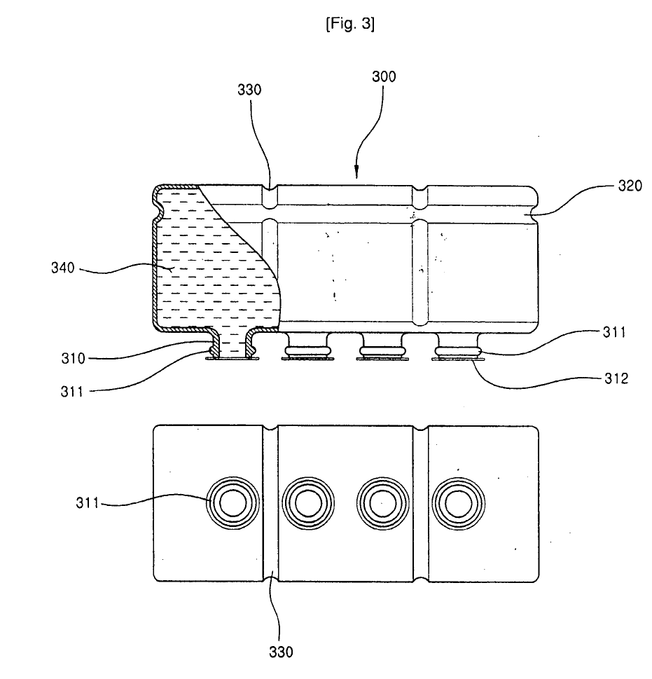

The electrolyte container 300 is shown in detail in FIG. 3.

This electrolyte container 300 is for keeping caustic potash solution, and soft polyethylene is preferable as the material.

As shown in FIG. 3, several outlets 310 are formed on the bottom of the electrolyte container 300, and after electrolyte 340 is filled, the outlet 310 is sealed with a sealing film 312 made of polyethylene film.

On the outer circumference of the outlet 310 is formed an outward protrusion 311 for the user to fit it tightly into the electrolyte filling inlet 221 as mentioned above, thereby preventing electrolyte from leaking. The electrolyte container 300 has a fastening slot 320 for joining the protrusion end 110 of the battery casing 100 and air guide slots 330 for exhaust air to escape. These slots 320 and 330 play also a role of increasing the mechanical strength of the electrolyte container 300.

Activation of the battery of the present invention constructed as above is made by injecting electrolyte.

The electrolyte container 300 filled with electrolyte 340 is kept in a state protruded further than the upper end of the battery casing 100. At this time, the electrolyte sealing film 312 is attached to the electrolyte outlet 310 of the electrolyte container 300.

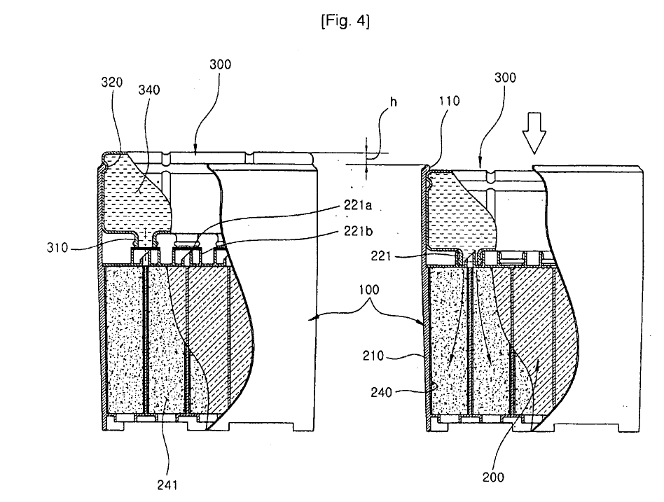

As shown in FIG. 4, applying external force to press the electrolyte container 300 makes further insertion into the battery casing 100 by as much as the gap h. At this time, the protrusion end 110 of the battery casing 100 that was inserted into the fastening slot 320 of the electrolyte container 300 comes off the fastening slot 320, catching the end portion (the upper end portion in the drawing) of the electrolyte container 300 so as to prevent the electrolyte container 300 from breaking away.

At the same time with this, the sealing film 312 is torn by the slant insert tube portion 221b protruded sharply in the protruded tube portion 221a of the electrolyte filling inlet 221 that is formed on the upper side of the battery stack 200, so that the electrolyte flows from the electrolyte container 300 into the battery stack 200.

The electrolyte that has flown in soaks zinc powder 241 of the battery, thereby generating electricity.

At this tire, on the outer circumference of the electrolyte outlet 310, the outward protrusion 311 is deformed by external force so as to come into close contact with the inner wall of the electrolyte filling inlet 221, so the electrolyte is prevented from leaking out.

Next will be described the method of manufacturing the cathode tube 230 with reference to FIG. 6.

The method of manufacturing the air cathode is widely known, but most of them are manufactured in a plate form, and some of the tubular forms are made by winding this plate-form electrode.

And they are in a form in which the inside is filled with electrolyte and the outside is contacted by air. But the present invention is in a form in which air flows in the inside and the outside is filled with electrolyte.

For a tubular cathode tube 230, we prepared a tubular copper tube. The copper tube was tubular with the diameter of 7 to 9 mm, length of 80 mm and thickness of 0.3, and the diameter for the both joint ends 231 was enlarged to fit the holder hole 222 of the cathode holder 220 and the bottom holding part of the battery casing 100, respectively.

The portion excluding both ends 231 of the copper tube is etched to form fine holes 233a, and the diameter of the hole made inside is 0.5 mm and the diameter of the hole made outside is about 0.2 mm. After plating this porous copper tube 233 with nickel several microns (mm) thick, the manufactured carbon paste was coated.

The carbon paste used here was a mixture of activated carbon and manganese dioxide powders with Teflon® particles. The carbon we used is a kind of activated carbon having a relatively high specific surface area of about 1,000 m²/g.

For carbon paste, we prepared one with Teflon® content of 60 to 90% by weight and another with Teflon® content of 30 to 60% by weight. We first coated the porous copper 233 with the former and then with the latter over it.

In the inside of this cathode tube, air should flow and liquid should not leak out, so it was to form a layer with higher hydrophobic characteristics in it.

Also, if necessary, we may put in the porous Teflon® tube in the cathode tube and adhere it to have perfect sealing.

Next, after drying it in a drying oven at 80 to 200° C., we put it in a mold and applied pressure in a press to make a tubular shape with an outer diameter of 111 mm, length of 80 mm and thickness of about 0.6 to 0.9 mm.

To reinforce the hydrophobic characteristics of the inner surface, we applied the inside of this tube with a brush with Teflon® dispersion liquid having 10 to 60% by weight of solid matter, and then heat-treated at 200 to 350° C. to complete the coated layer 232. When heat-treated at this temperature, Teflon® particles inside are mutually connected to make a structure for holding carbon particles immovable.

Because the outside of this cathode tube has a small content of Teflon® and a large internal surface, it is relatively hydrophilic, but the inside has hydrophobic characteristics, so it prevents electrolyte from entering into the tube.

Next will be described the method of combining with the plastic structure of the cathode tube 230.

The cathode tube, as shown in FIG. 7, has the joint ends 231 exposed at both end. By using the exposed portion, the upper end of the tubular cathode tube is adhered to the cathode tube holder 220 of the plastic structure of the battery. Epoxy resin adhesive agent is used to adhere both ends of the copper tube 233 to the battery body.

To prevent leakage from penetration to the adhered portion, a sleeve 223 made of steel plate material was used to press down the adhered portion.

A metal bar was put in the cathode tube 230 and force was applied from outside to bend the sleeve made of steel plate material for mechanically tighter contact.

Next will be described the method of manufacturing a multiple rectangular copper tube anode.

In the present invention, we tested both the case where there is internal partition in the plastic battery stack and the case where there is not.

In the case where there is internal partition, the partition should be at least 1 to 2 mm thick if it is made by plastic injection molding, so the weight is increased and the quantity of electricity is decreased. Therefore, the case of no internal partition is more advantageous in terms of electrical capacity, but we can get the same effect with the anode plates 242.

At this time, it is preferable to make and use multiple cells by using a thin anode plate. As shown in FIG. 8, coat the whole of one side of the metal copper plate and the upper and lower edges of the other side with an electrically insulating material such as epoxy and fold it to make unit cells.

Fold in such a way that the coated portion 243, in which the whole is coated with epoxy, is faced outward, and the coated portion 243, in which only the edges are coated so the metal surface is exposed, is faced inward. And attach each other the unit cells made that way so as to be suitable for series connection, and also at this time, use epoxy coating agent to attach the cells together.

This way, as shown in the last drawing of FIG. 8, a multiple battery stack, in which the coated portion 243 adhered with epoxy resin is electrically insulated each other, is formed, and the internal space can be saved, so it is possible to put in a larger quantity of zinc powder and electrolyte.

### INDUSTRIAL APPLICABILITY

The zinc-air battery of the present invention can be used as an emergency battery since it is possible to keep it permanently as long as electrolyte is not supplied with zinc powder by pressing the electrolyte container, and the electrolyte container that has already started to be supplied with electrolyte will not come off by itself and has a structure for smooth supply of electrolyte, so sufficient electricity is supplied until all the electrolyte is consumed. Therefore, it can be put to a good use in various electrical products and devices that need a disposable battery.

1. A zinc-air battery, in which a zinc plate or metal zinc powder is used as anode, and air or oxygen is used as oxidizer, and aqueous solution of caustic potash is used as an electrolyte, the zinc-air battery comprising:
an electrolyte container 300 containing electrolyte,
a battery stack 200 that is arranged under said electrolyte container 300 so as to have electrolyte supplied when necessary from said electrolyte container 300, and
a battery casing 100 that houses both said electrolyte container 300 and battery stack 200.

2. The zinc-air battery according to claim 1, wherein said electrolyte container 300 is provided with a plurality of electrolyte outlets 310 that are formed at the bottom in a protrusion shape so as to be inserted into the inside of said battery casing 100.

3. The zinc-air battery according to claim 2, wherein each of the electrolyte outlets 310 of said electrolyte container 300 maintains a sealed state after electrolyte is filled, and is sealed by a sealing film 312 that allows electrolyte be discharged if it is penetrated.

4. The zinc-air battery according to claim 2, wherein an outward protrusion 311 that can raise the sealing power is formed on the outer circumference of the electrolyte outlet 310 of said electrolyte container 300.

5. The zinc-air battery according to claim 1, wherein said electrolyte container 300 has a size that fits into the upper half of said battery casing 100, and a fastening slot 320 is formed on the outer circumference to be inserted the inward protrusion end 110 of said battery casing 100 so that a temporary position can be held immovable.

6. The zinc-air battery according to claim 1, wherein said electrolyte container 300 is prevented from breaking away because, when its exposed top surface is pressed while it is inserted in said battery casing 100, the exposed top surface is inserted lower than the inward protrusion end 110 of said battery casing 100.

7. The zinc-air battery according to claim 1, wherein said electrolyte container 300 has air-flowing slots 330, which induces air to flow to the inside of said battery casing 100, formed on the outer circumference.

8. The zinc-air battery according to claim 1, wherein the electrolyte filled in said electrolyte container 300 is caustic potash solution.

9. The zinc-air battery according to claim 1, wherein said battery stack 200 comprises a stack case 210 having a predetermined internal space 211,
a plurality of anode tubes 240 inserted into said stack case 210,
zinc powder 241 filled in said anode tubes 240,
a cathode holder 220 arranged so as to seal the upper side and lower side of said stack case 210 and having a plurality of holder holes 222, and
a plurality of cathode tubes 230, in which the upper and lower ends are supported by the holder hole 222 of said cathode holder 220 and the bottom holding part of the battery casing 100, respectively, and air can be moved to the center.

10. The zinc-air battery according to claim 9, wherein each of said anode tubes 240 made in rectangular shapes by bending thin copper plates is coated with electric insulation-coated portion 243 on the whole of the outer side and the upper and lower ends of the inner side.

11. The zinc-air battery according to claim 10, wherein the electrical insulation-coated portion 243 of said anode tube 240 is made of electrically insulating polymer adhesive agent for multiple connections, and the anode tubes 240 are housed in said stack case 210 while they are continuously connected each other by said electrical insulation-coated portion 243.

12. The zinc-air battery according to claim 9, wherein each of said cathode tubes 230 has a plurality of fine holes 233a formed on the cylindrical surface excluding the upper and lower joint ends 231 for air to flow inward, and a catalyst-coated layer 232 is applied on the circumference that has the fine holes formed.

13. The zinc-air battery according to claim 12, wherein said catalyst-coated layer 232 is composed of a primary coated layer 232a made of activated carbon mixed with Teflon® content of 60 to 90% by weight ratio, and a secondary coated layer 232b made of activated carbon mixed with Teflon® content of 30 to 60% by weight ratio.

14. The zinc-air battery according to claim 9, wherein the cathode holder 220 of said battery stack 200 is provided with a plurality of protrusion rims 222a formed on the circumference of said holder hole 222, and after the cathode tube 230 is inserted into each of holder holes 220, the protrusion rim 222a around the holder hole 222 and the upper joint end 231 of the cathode tube 230 is joined by means of a metal sleeve 223.

15. The zinc-air battery according to claim 14, wherein said cathode holder 220 is arranged between holder holes 222, further comprises a plurality of electrolyte filling inlets 221 for injecting electrolyte.

16. The zinc-air battery according to claim 15, wherein the electrolyte filling inlet 221 of said cathode holder 220 has a dual structure consisted of a protruded tube portion 221a and a slant insert tube portion 221b arranged in the center of the protruded tube portion, so that the slant insert portion 221b can prick to break said sealing film 312.
